(19) United States
(12) Patent Application Publication
(10) Pub. No.: US 2005/0279912 A1
(43) Pub. Date: Dec. 22, 2005

(54) Outboard motor lift

(75) Inventor: Guy R. Kozubski, McGehee, AR (US)

Correspondence Address: John M. Harrison, 2139 E. Bert Kouns, Shreveport, LA, 71105, US

(73) Assignee: William F. Denton

(21) Appl. No.: 11/184,755

(22) Filed: Jul. 19, 2005

Related U.S. Application Data
(63) Continuation-in-part of application No. 10/609,354, filed on Jun. 30, 2003.

(51) Int. Cl. F16M 1/00

(52) U.S. Cl. 248/642

(57) ABSTRACT

An outboard motor lift is characterized by a lift assembly fitted to the transom of a boat and including parallel upper and lower links joining a bracket system attached to the boat transom with a motor mount bracket carrying an outboard motor, such that the outboard motor can move freely vertically up and down with respect to the transom responsive to contacting an underwater obstacle. Under circumstances where the outboard motor is heavy a spring system may be added to the lift assembly to offset the motor weight and facilitate vertical movement of the outboard motor by operation of the parallel links with minimal force when the outboard motor contacts the underwater obstacle. A handle coupled to another set of parallel links and a lift mechanism facilitate vertical adjustment and support of the lift assembly links and the outboard motor at selected operating positions. Since the outboard motor is positioned in spaced-apart relationship with respect to the transom, a throttle extension may be provided for comfortably operating the motor throttle when the lift assembly is in functional configuration.

### CROSS-REFERENCE TO RELATED APPLICATIONS

This application is a Continuation-In-Part of application Ser. No. 10/609,354, Filed Jun. 30, 2003.

### BACKGROUND OF THE INVENTION

### Field of the Invention

This invention relates to devices for protecting foot, the lower unit and propeller of an outboard motor from damage due to shallow water running and/or collision with underwater obstacles and more particularly, to a lift assembly for mounting on the transom of a boat, wherein the outboard motor is allowed to move freely substantially vertically up and down with respect to a selected supporting position, responsive to contact with the water body bottom or underwater obstacles.

One of the problems associated with outboard motors which are mounted in fixed position on the transom of a boat is striking underwater obstacles, which often causes damage to the foot, propeller and/or lower unit of the motor. Most outboard motors are equipped with a conventional lock/release device which facilitates kicking of the lower unit and foot rearwardly in an arc and tilting of the motor head forwardly about a point of pivot at or near the transom of the boat, to minimize damage due to such underwater collisions. Other devices are known which will cause a similar upward movement of the lower unit and foot of a motor at the point of pivot of the motor on the transom. All of these systems suffer from the disadvantage of requiring a considerable force to trip the latching mechanism holding the motor in a normal operating configuration, thereby increasing the likelihood of damage to the lower unit and/or the foot or propeller of the motor due to striking of the underwater obstacle. These devices also rely on adjustment locking features that must be manipulated to facilitate a change in the vertical positioning of the motor.

### SUMMARY OF THE INVENTION

The outboard motor lift of this invention is designed to allow shallow water operation of boats having outboard motors, without damaging the submerged motor components due to striking the water bottom and/or underwater obstacles. The outboard motor lift facilitates free, uninhibited upward movement of an outboard motor vertically upon striking an underwater obstacle, including a water body bottom, and return to a preselected support position. The device includes a lift assembly which is characterized by a transom bracket for mounting on the transom of a boat and parallel sets of upper and lower links pivotally attached to the transom bracket and to a motor mount bracket for fitting on a motor mount which receives and mounts the outboard motor. An adjustable support and handle/linkage combination is also provided for supporting the links in a desired pivoted position with respect to the boat transom, but allowing free up and down movement of the links and the motor from the selected adjustable point of support. Accordingly, the outboard motor is allowed to freely move or “float” vertically from the selected point of support, under circumstances where the lower unit, propeller or foot strikes the water bottom or an underwater obstacle while the boat is moving, and then to drop back onto the support. The relative position of the outboard motor with respect to the transom of the boat is adjustably determined by the handle and cooperating handle mount and linkage support apparatus while the boat is still or running. The linkage support apparatus contacts the underside of the bottom set of parallel sets of upper and lower links to facilitate adjustably positioning the outboard motor in a desired upward or downward position. In a preferred embodiment the handle is fitted with a grip lever and spring-biased lever cable, the latter of which connects to a pawl and pawl spring arrangement that selectively engages and disengages corresponding teeth in the handle linkage. This arrangement allows control of the handle with respect to the handle linkage assembly and the outboard motor under circumstances where it is desired to adjust the height of the upper and lower links and thus, the outboard motor, with respect to the transom of the boat. It is particularly important to note that the handle/linkage support assembly used for adjusting the height of the outboard motor with respect to the transom of the boat does not at any time latch or lock the lift assembly into the selected supporting position during operation of the boat. Rather, the handle and handle linkage/support apparatus is designed to support the parallel upper and lower links in a selected position, thus controlling the desired operational height of the outboard motor mounted on the lift assembly. Accordingly, at all times, the lift assembly and the outboard motor are permitted to move upwardly away from the supporting linkage/support assembly, should the skid or skeg, propeller, lower unit or foot of the outboard motor strike a submerged obstacle or the bottom, thereby minimizing damage to the outboard motor. Furthermore, a system of springs and associated cables may be provided in the lift assembly to apply upward tension on the lift assembly and offset the weight of the motor under circumstances where the motor is large and heavy. The spring or springs are sized such that the spring tension offsets the weight of the outboard motor and the force required to lift the outboard motor and lift assembly when the outboard motor strikes an underwater obstacle is minimal.

### BRIEF DESCRIPTION OF THE DRAWINGS

The invention will be better understood by reference to the accompanying drawings, wherein:

FIG. 1 is a front perspective view of a preferred embodiment of the lift assembly of this invention with the attached outboard motor positioned in a partially raised configuration to support the outboard motor in a desired position with respect to the transom of a boat;

FIG. 2 is a rear perspective view of the lift assembly illustrated in FIG. 1, wherein the motor is detached from the motor mount element of the lift assembly and the lift assembly is displaced downwardly with respect to the position illustrated in FIG. 1 by operation of a control handle and linkage/support apparatus;

FIG. 3 is a perspective view of a throttle extension which may be utilized to extend the throttle arm or handle of the outboard motor illustrated in FIGS. 1 and 2;

FIG. 4 is a side elevation of the outboard motor lift assembly and boat illustrated in FIG. 2, more particularly illustrating the lowered position of the lift assembly and outboard motor responsive to upward pivoting of the control handle;

FIG. 5 is a side elevation of the motor and lift assembly illustrated in FIG. 4, more particularly illustrating upward movement of the outboard motor and the lift assembly with respect to the transom of the boat by upward pivoting of the handle to the position illustrated;

FIG. 6 is a side elevation of the outboard motor and lift assembly illustrated in FIGS. 1, 4 and 5, more particularly illustrating free upward pivoting, or “floating” of the motor and lift assembly with respect to the transom of the boat responsive to striking of an underwater obstacle or the water body bottom by the foot or motor skid or skeg element of the outboard motor;

FIG. 7 is a rear perspective view of the lift assembly illustrated in FIGS. 1-6, more particularly illustrating a typical normal operating position for the outboard motor, as illustrated in FIG. 5 of the drawings;

FIG. 8 is a front perspective view of the lift assembly illustrated in FIG. 7, more particularly illustrating the lift assembly in raised configuration for lifting the outboard motor responsive to striking of an underwater obstacle or bottom, as illustrated in FIGS. 1 and 6 of the drawings;

FIG. 9 is a partially exploded view of the motor mount and handle elements of the lift assembly illustrated in FIG. 7 of the drawings;

FIG. 10 is a partially exploded view of the upper and lower sets of links and the motor mount bracket system of the lift assembly illustrated in FIG. 9 of the drawings;

FIG. 11 is an exploded view of the transom bracket and optional spring and cable system for use in the lift assembly illustrated in FIGS. 9 and 10 of the drawings; and

FIG. 12 is an exploded view of a preferred control handle and handle mount assembly for effecting a desired vertical positioning of the outboard motor and the lift assembly illustrated in FIGS. 1-11 of the drawings.

### DESCRIPTION OF THE PREFERRED EMBODIMENTS

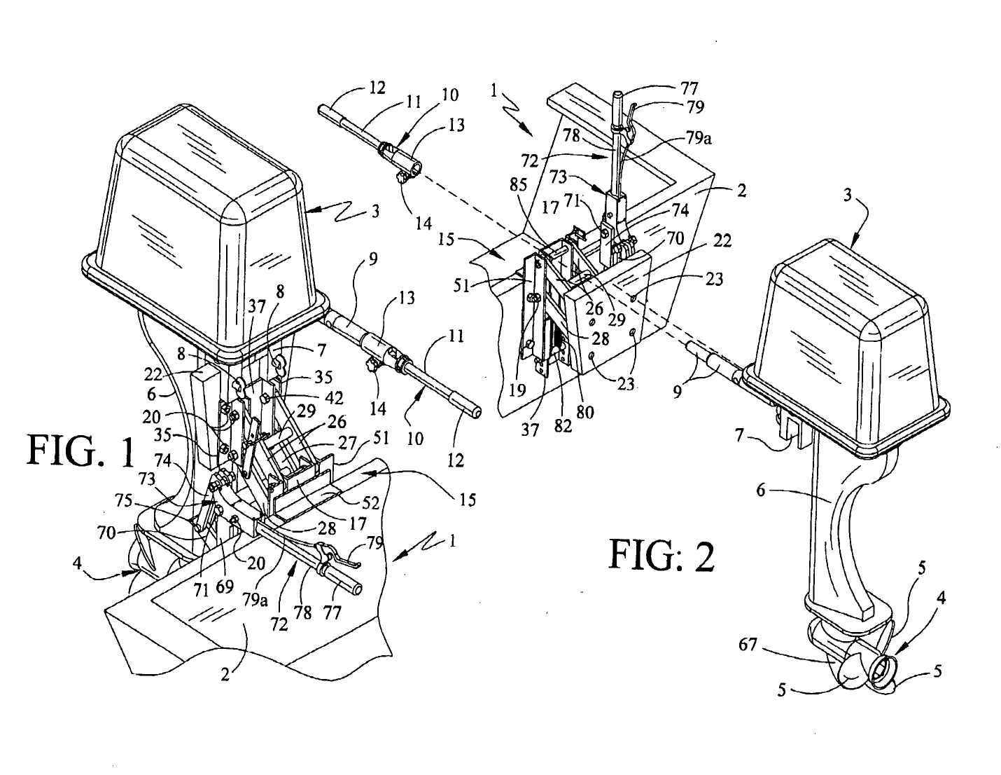

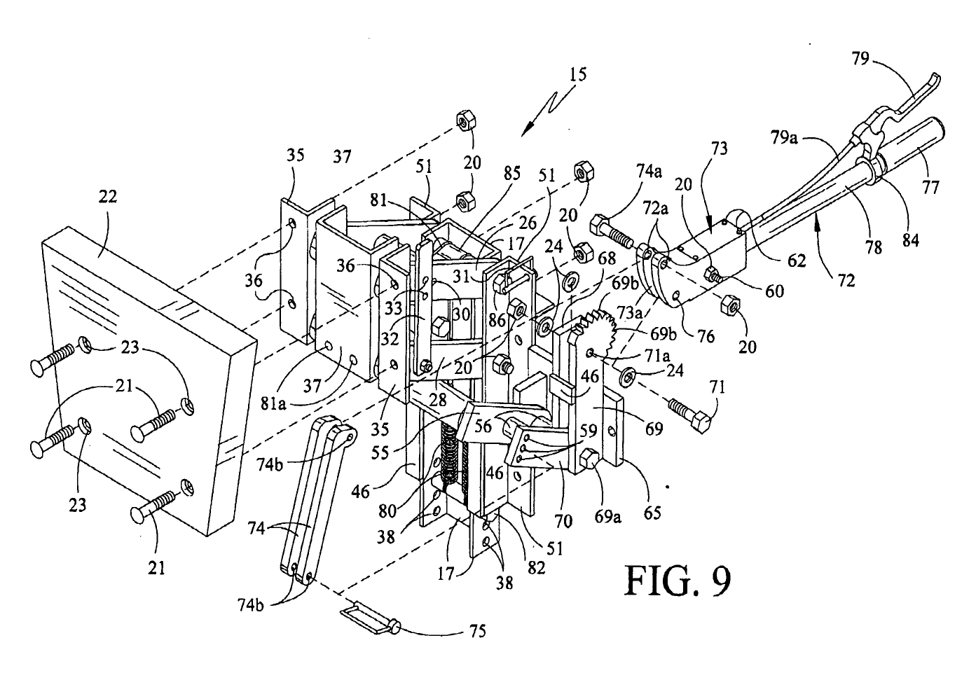

Referring initially to FIGS. 1, 2 and 7-9 of the drawings, in a preferred embodiment the lift assembly of this invention is generally illustrated by reference numeral 15 and is designed for mounting on the transom 2 of a boat 1 (FIGS. 1 and 2) to position an outboard motor 3 in spaced-apart relationship with respect to the transom 2, as illustrated. The outboard motor 3 is typically characterized by a conventional propeller 4, having propeller blades 5 mounted on a lower unit 6 and fitted with a downwardly-extending motor skeg 67, as further illustrated in FIG. 2 of the drawings. A conventional motor bracket 7 is provided on the outboard motor 3, as further illustrated in FIGS. 1 and 2 and typically includes one or more thumb screws 8 for tightening against the transom 2 of the boat 1 in a conventional mounting configuration. However, under circumstances where the outboard motor lift of this invention is utilized the motor bracket 7 is fitted over a motor mount 22, having spaced-apart motor mount openings 23 that receive corresponding motor mount bolts 21 (FIG. 9). The motor mount bolts 21 are designed to extend through the motor mount openings 23 and corresponding motor mount bracket openings 36, provided in a pair of angled-iron motor mount brackets 35, for securing to the motor mount brackets 35 by nuts 20, as further illustrated in FIGS. 8 and 9 of the drawings. In a preferred embodiment a channel-shaped center motor mount plate 37 is interposed between the two motor mount brackets 35 and is attached thereto by means of corresponding link mount bolts 42. The link mount bolts 42 also serve to pivotally connect one end of respective pairs or sets of parallel upper links 26 and lower links 28 to the corresponding center motor mount plate 37 between the center motor mount plate 37 and the respective motor mount brackets 35. The link mount bolts 42 are each typically secured by nuts 20 and extend through aligned openings provided in the motor mount brackets 35 and the center motor mount plate 37.

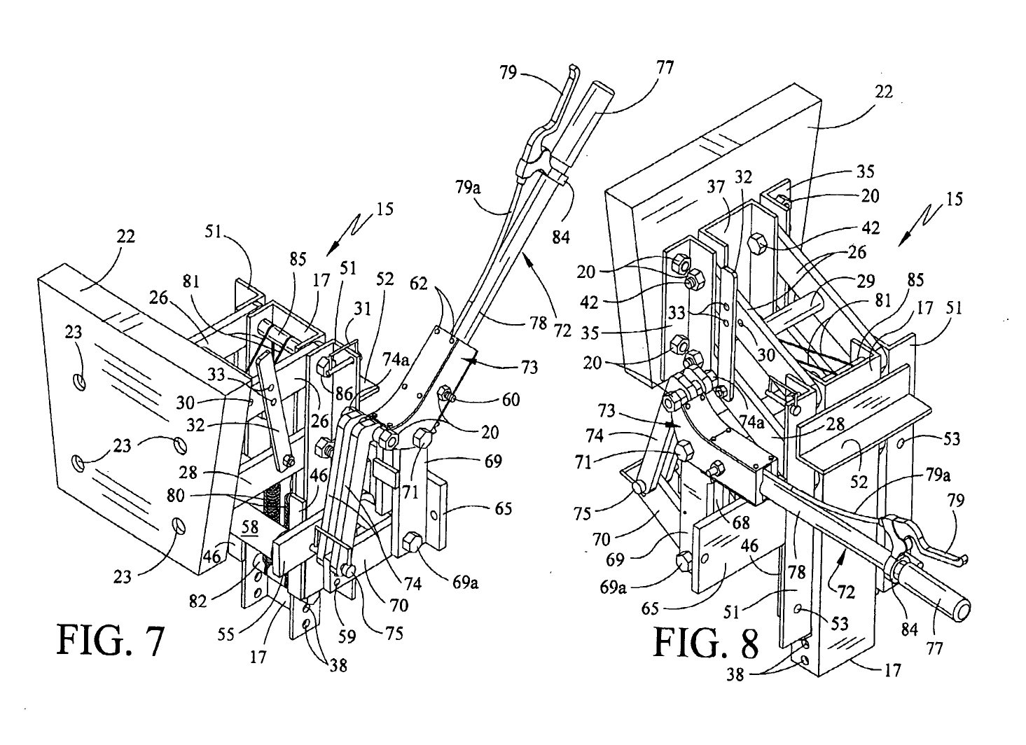

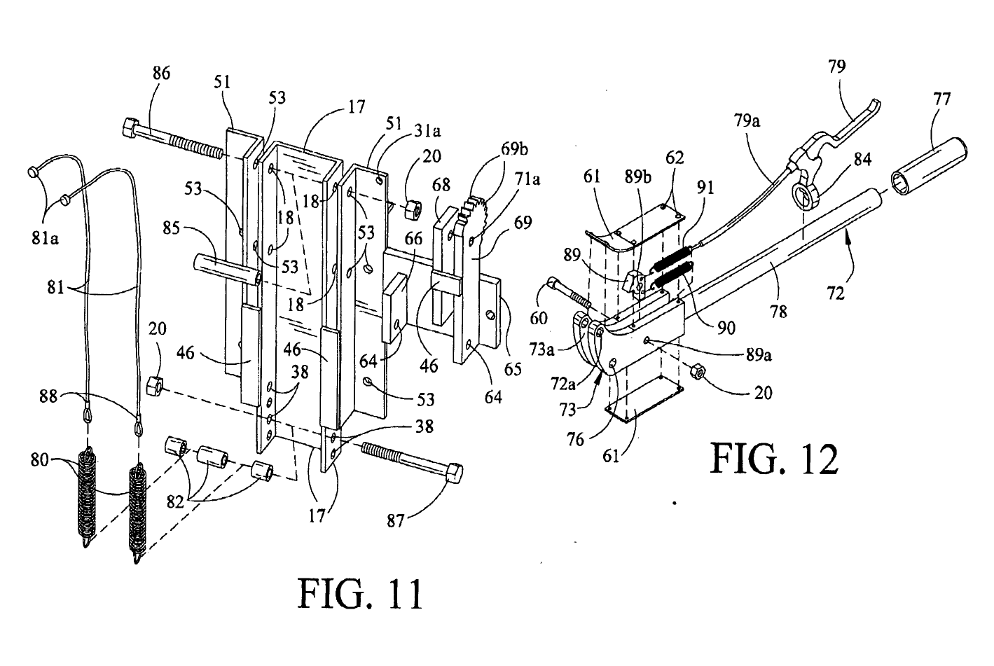

As further illustrated in FIGS. 7-10 of the drawings, the opposite ends of the respective sets of upper links 26 and lower links 28 are pivotally attached to a center transom mount plate 17, which is generally channel-shaped as illustrated. The outwardly-extending flanges of the center transom mount plate 17 are further provided with transom mount plate openings 18 (FIG. 11) that align with corresponding transom mount bracket openings 53, provided in the adjacent pair of transom mount brackets 51. A transom mount bracket 52 spans the center transom mount plate 17 and the adjacent transom mount brackets 51 and acts as a mounting guide for the center transom mount plate 17. Transom mount bolts 19 extend through transom mount bracket openings 53 in the respective transom mount brackets 51, through the transom 2 of the boat 1 (FIG. 2) to secure the lift assembly 15 on the transom 2 using corresponding nuts (not illustrated). In another preferred embodiment of the invention each of the parallel sets of upper links 26 and lower links 28 are fitted with a link spacer 29 (FIG. 8) and the upper links 26 and lower links 28 are designed to facilitate free “floating” movement of the motor mount 22 up and down above a preselected, set supporting position, while the sets of upper links 26 and lower links 28 remain parallel to each other. Accordingly, under circumstances where the outboard motor 3 is clamped to the motor mount 22 as illustrated in FIG. 1 of the drawings, the outboard motor is allowed to “float” up and down above an adjustable support element, by operation of the upper links 26 and the lower links 28, to minimize damage to the propeller 4, propeller blades 5, motor skeg 67 and the lower unit 6 of the outboard motor 3, upon striking of the water bottom or an underwater obstacle, as further hereinafter described.

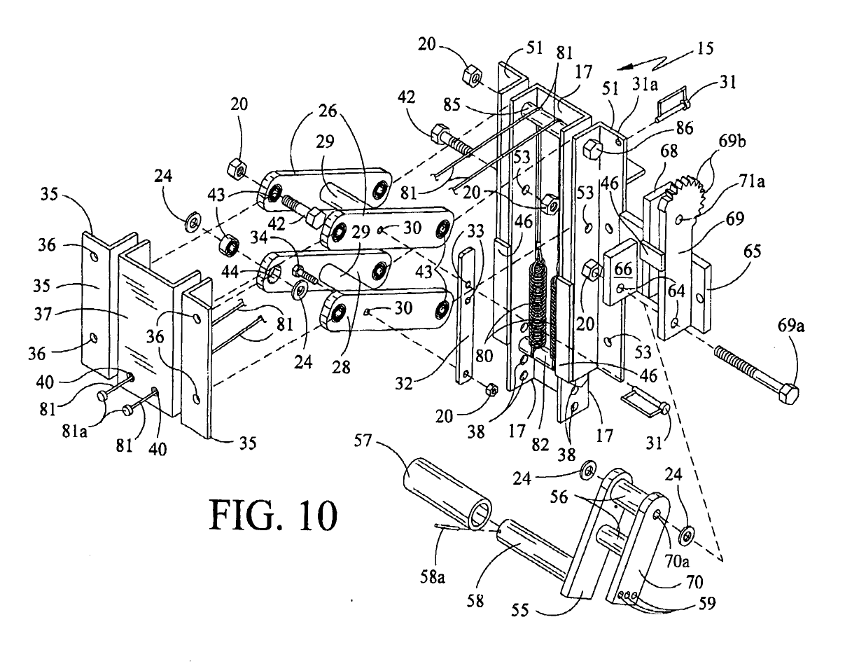

Referring again to FIGS. 1 and 7-9 of the drawings, a lock bar 32 can be fitted to one of the lower links 28 by means of a link connecting bar bolt 34 and a corresponding nut 20 (FIG. 10). Furthermore, the upper segment of the lock bar 32 is provided with vertically spaced-apart bar adjusting openings 33 for receiving a lock bar pin 31 that extends through a selected bar adjusting opening 33 and a corresponding link opening 30 provided in the upper link 26 (FIG. 1), to selectively lock the travel of the upper links 26 and the lower links 28 for transportation and storage, when the lock bar pin 31 is not in use it can be inserted in a hole in a transom mount bracket 41, as illustrated in FIGS. 7-10. As further illustrated in FIG. 10 of the drawings, in another preferred embodiment, bearings or bushings 43 are seated in corresponding bearing or bushing openings 44 provided in the respective ends of the upper links 26 and lower links 28, and washers 24 are interposed between adjacent bearings or bushings 43, to reduce friction and facilitate ease in the parallel pivoting of the respective sets of upper links 26 and lower links 28 during operation of the lift assembly 15. As further illustrated in FIG. 10, a pair of cable access openings 40 are provided in spaced-apart relationship at the bottom end of the center motor mount plate 37 for receiving a pair of spring cables 81, fitted with cable stays 81a at the ends thereof and extending over a tensioning bar 85 and downwardly, to a pair of springs 80. The tensioning bar 85 is typically mounted on the center transom mount plate 17 by a tensioning bar bolt 86 and a nut 20. In a preferred embodiment of the invention the extending ends of the spring cables 81 are fitted with cable loops 88 for engaging the ends of the respective springs 80, as illustrated in FIG. 11 of the drawings. The opposite ends of the springs 80 from the spring cables 81 are attached to a spring mount bolt 87, which extends through a selected one of a set of vertically spaced-apart tension adjustment openings 38, provided in the flange elements of the center transom mount plate 17, as further illustrated in FIG. 11 of the drawings. In a preferred embodiment a series of spring mount spacers 82 are fitted on the spring mount bolt 87 adjacent to the flanges in the center transom mount plate 17, to space the connected ends of the springs 80 from each other and facilitate proper tensioning of the springs 80 during operation of the lift assembly 15, as hereinafter further described. The spring mount bolt 87 is secured in place in a selected one of the tension adjusting openings 38 by means of a nut 20 and is positioned in the appropriate tension adjusting opening 38 to facilitate a desired degree of tension on the springs 80. This selected tension is commensurate with the weight of the outboard motor 3 which is mounted on the mount 22, as further illustrated in FIG. 1 of the drawings.

Referring now to FIGS. 7-10 and 12 of the drawings, in another preferred embodiment of the invention the lift assembly 15 is characterized by a handle mount 73 which mounts one end of a handle 78, having a handle grip 77 at the end thereof. In a preferred embodiment a bifurcation 73a is provided in the handle mount 73 for receiving the top end of a toothed bar 69, which top end is fitted with bar teeth 69b, as further illustrated in FIGS. 9-11 of the drawings. As illustrated in FIG. 12, the bifurcation 73a is typically covered at the top and bottom of the handle mount 73 by a pair of handle assembly plates 61, fitted with corresponding plate screws 62. The bifurcation 73 pivotally accommodates a pawl 89, having a pawl spring 90, for normally biasing the pawl 89 against the respective bar teeth 69b on the tooth bar 69 when the handle mount 73 is assembled on the toothed bar 69 with the top end of the toothed bar 69 extending into the bifurcation 73a. A handle assembly bolt 60 extends through a corresponding pawl pivot opening 89a in the handle mount 73 and through a corresponding, aligned pawl opening 89b in the pawl 89, for securing the pawl 89 pivotally inside the bifurcation 73a. The handle assembly bolt 60 is typically maintained in position by a nut 20. A handle mount bolt 71 projects through aligned handle mount bolt openings 76 in the handle mount 73 and through a tooth bolt opening 71a in the toothed bar 69, to pivotally mount the handle 72 on the toothed bar 69. A lever cable 79a extends from a cable spring 91, secured to the pawl 89, to a lever mount ring 84 and grip lever 79 assembly, which lever mount ring 84 is attached to the handle bar 78 of the handle 72. Accordingly, depressing of the grip lever 79 tensions the lever cable 79a and the cable spring 91 and causes the pawl 89 to pivot on the handle assembly bolt 60, disengage the corresponding bar teeth 69b provided on the tooth bar 69 and facilitate free rotation of the handle 72 about the top end of the toothed bar 69. As further illustrated in FIGS. 10 and 11 of the drawings, a stabilizing bar 68 is welded or otherwise attached to a spacer plate 65 in parallel relationship with respect to the toothed bar 69 and a bracket spacer bar 46 is welded to both the stabilizing bar 68 and the toothed bar 69, to strengthen the toothed bar 69 responsive to operation of the handle 72.

Referring again to FIGS. 7-10 of the drawings, the extending end of the handle mount 73 is fitted to one end of each of a pair of spaced-apart lift bar links 74 in the bifurcation 73a at the link bolt openings 72a, by means of a corresponding lift bar link bolt 74a, which also extends through the lift bar link openings 74b, and is secured in place by a nut 20. The bottom ends of the lift bar links 74 are similarly connected to a lift bar 70 by means of a link connecting pin 75, which extends through the aligned lift bar link openings 74b in the bottom ends of the lift bar links 74 and through a selected one of three lift bar adjusting openings 59 in the lift bar 70. Moreover, the top end of the lift bar 70 has a lift bar opening 70a, for receiving a toothed bar bolt 69a, that extends through a pair of washers 24 and an aligned bar opening 64 in the toothed bar 69, for pivotally assembling the lift bar 70 on the fixed toothed bar 69. Accordingly, pivoting of the handle 72 on the toothed bar 69 facilitates a corresponding pivoting of the lift bar link 74 with respect to the handle mount 73 and the lift bar 70 and raising and lowering of the lift bar 70, for purposes which will be hereinafter further described. The lift bar 70 is disposed in parallel relationship with respect to a corresponding connecting bar 55 and is joined thereto by a pair of bar connectors 56, as further illustrated in FIG. 10 of the drawings. A lift sleeve mount 58 extends from the bottom end of the connecting bar 55 and is designed to removably receive a corresponding lift sleeve 57, which is typically connected to the lift sleeve mount 58 by a mount pin 58a (FIG. 10). The lift sleeve 57 extends beneath the parallel lower links 28 and manipulation of the arm 72 thus causes the corresponding lift bar 70, connecting bar 55 and lift sleeve 57 to move up and down, thereby manipulating the sets of lower links 28 and upper links 26 upwardly and downwardly to adjust the height of the outboard motor 3, as further hereinafter described. The three, spaced-apart lift bar adjustment openings 59, provided in the bottom end of the lift bar 70 (FIG. 9), receive the link connecting pin 75 (FIG. 9) and facilitate adjusting the linkage of the bottom ends of the respective lift bar links 74 on the lift bar 70. This adjustment also determines the range of motion necessary in the handle 72 on the toothed bar 69 to move the lift bar 70, connecting bar 55 and the lift sleeve 57 upwardly or downwardly and thus, the adjustment of the parallel upper links 26 and lower links 28 to set the height of the outboard motor 3 with respect to the transom 2 of the boat 1.

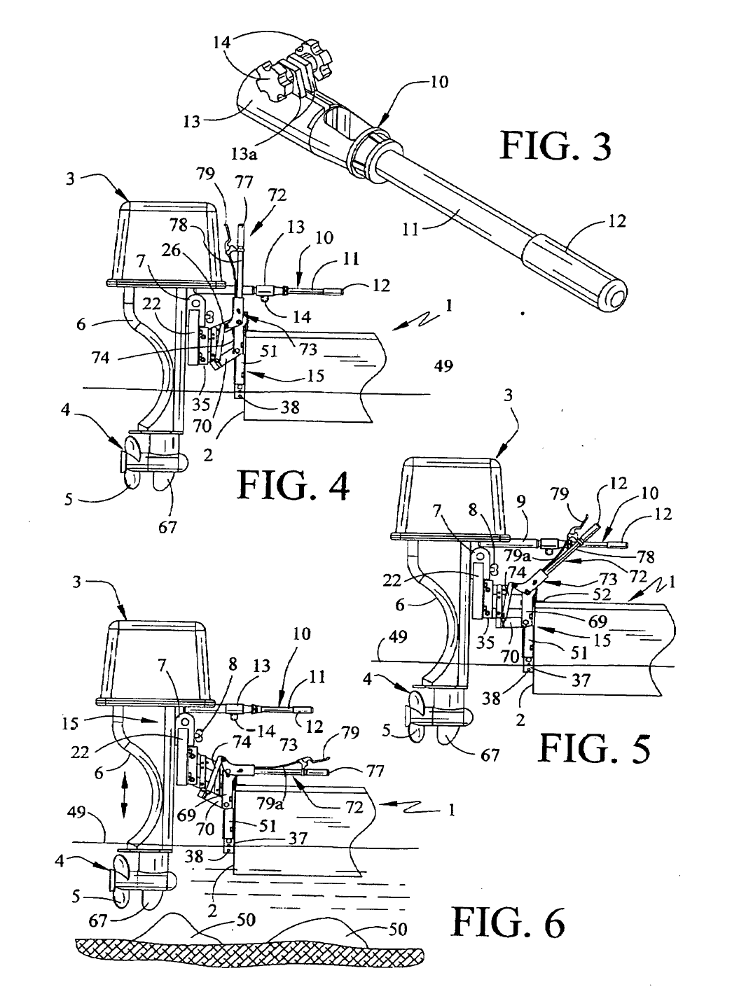

Referring now to FIGS. 1 and 3 of the drawings, in another preferred embodiment of the invention a throttle extension 10 is provided and includes an extension arm 11, fitted on one end with an extension arm grip 12 and on the opposite end with an arm engaging sleeve 13. The arm engaging sleeve 13 of the throttle extension 10 is designed to fit over the conventional throttle grip 9 on an outboard motor 3 which is so equipped, and a pair of upwardly-extending sleeve flanges 13a is fitted with an engaging sleeve tightener 14 to allow tightening of the arm engaging sleeve 13 on the throttle grip 9 of the outboard motor 3. Consequently, manipulation of the extension arm grip 12 rotates the extension arm 11 and the throttle extension 10 as well as the throttle grip 9 of the outboard motor 3 and facilitates throttle control of the outboard motor 3.

Referring to FIGS. 4-6, 7 and 8 of the drawings, under circumstances where the outboard motor 3 is to be positioned in a selected normal operating configuration, the handle grip 77 of the handle 72 is grasped, the grip lever 79 is depressed to extend the cable spring 91 and the handle 72 is moved upwardly to disengage the pawl 89 from the bar teeth 69b in the position illustrated in FIG. 4, and lower the outboard motor 3 by corresponding movement of the lift bar links 74, lift bar 70, connecting bar 55 and lift sleeve 57 downwardly. Since the pawl 89 is now again locked into a bar tooth 69b corresponding to the adjusted position of the outboard motor 3 by operation of the pawl spring 90 (FIG. 12), the outboard motor 3 cannot move further downwardly, but is free to move and “float” upwardly, and then back downwardly to the adjusted point of support, if the propeller 4 or propeller blades 5 or the motor skeg 67 contact the water bottom or an underwater obstacle 50, below the waterline 49 (FIG. 6). Accordingly, referring again to FIG. 6 of the drawings, under circumstances where the motor skeg 67 encounters the water bottom or underwater obstacle 50, the outboard motor 3 is forced upwardly in a “floating” action, such that the motor skeg 67 easily bounces over the bottom or the underwater obstacle 50 and then returns by gravity to rest on the lift sleeve 57 (FIG. 10) without damaging the propeller 4, propeller blades 5 or the lower unit 6, as well as the motor skeg 67, of the outboard motor 3.

Furthermore, under circumstances where it is desired to facilitate an upward positioning of the outboard motor 3 to a new elevation such that the propeller 4 and propeller blades 5 operate more shallow than the position illustrated in FIG. 4, the grip lever 79 is again depressed to tension the cable spring 91 and the handle 72 is again manipulated downwardly to the position illustrated in FIG. 5, thus raising the lift bar 70, the connecting bar 55 and the corresponding lift sleeve 57 and consequently, raising the parallel upper links 26 and lower links 28 to approximately a horizontal configuration, as illustrated. This position also facilitates “free floating” of the outboard motor 3 upwardly from the new resting position on the lift sleeve 57, since the lift assembly 15 is not locked into position thereon, such that any encounter with a shallow sandbar, water bottom or an underwater obstacle 50 by the motor skeg 67 (FIG. 6) will facilitate immediate upward movement of the outboard motor 3 by operation of the parallel upper links 26 and lower links 28, without damage to the propeller 4, propeller blades 5 or the motor skeg 67.

It will be appreciated by those skilled in the art that the above described upward and downward manipulation of the handle 72 can be effected both while the boat 1 is still and while it is running. A quick movement of the handle 2 in either direction in a short arc after depressing the grip lever 79 effects a desired lifting or lowering of the outboard motor 3 to accommodate a shallow water bottom, stumps, logs, sandbars and like submerged obstacles, as desired. Moreover, movement of the handle with extreme downward position raises the motor into a travel or stored position, such as the position illustrated in FIG. 1, wherein the lock bar pin 31 can be inserted in the aligned lock bar adjustment openings 33 in the lock bar 32 and the link opening 30 in the lower link 28.

While the preferred embodiments of the invention have been described above, it will be recognized and understood that various modifications may be made in the invention and the appended claims are intended to cover all such modifications which may fall within the spirit and scope of the invention.

1. A lift assembly for mounting an outboard motor on the boat transom of a boat, comprising a transom bracket for mounting on the boat transom; a motor mount bracket spaced-apart from said transom bracket for mounting the outboard motor; a pair of upper links pivotally connected to said transom bracket and said motor mount bracket; a pair of lower links spaced from said upper links, said lower links pivotally connected to said transom bracket and said motor mount bracket; and a support mechanism carried by said transom bracket, said support mechanism extending beneath said lower links for engaging and supporting said lower links and positioning the outboard motor in a selected motor operating configuration, wherein said upper links and said lower links pivot freely upwardly with the outboard motor when the outboard motor strikes an underwater obstacle.

2. The lift assembly of claim 1 wherein said support mechanism comprises a control handle; a pawl pivotally provided on said control handle; a toothed bar carried by said transom bracket for releasable engagement with said pawl; a release device carried by said control handle and connected to said pawl for selectively causing engagement of said pawl and said toothed bar; and a link support apparatus pivotally connected to said control handle for engaging said lower links and selectively raising and lowering said lower links and the outboard motor responsive to manipulation of said release device and said control handle.

3. The lift assembly of claim 1 wherein the outboard motor has a throttle arm and comprising a throttle extension provided on the throttle arm of the outboard motor for extending operation of the throttle arm of the outboard motor.

4. The lift assembly of claim 3 wherein said support mechanism comprises a control handle; a pawl pivotally provided on said control handle; a toothed bar carried by said transom bracket for releasable engagement with said pawl; a release device carried by said control handle and connected to said pawl for selectively causing engagement of said pawl and said toothed bar; and a link support apparatus pivotally connected to said control handle for engaging said lower links and selectively raising and lowering said lower links and the outboard motor responsive to manipulation of said release device and said control handle.

5. The lift assembly of claim 2 wherein said link support apparatus comprises a pair of lift bar links pivotally connected to said control handle; a lift bar pivotally connected to said lift bar links; and a lift sleeve carried by said lift bar for engaging and supporting said lower links and positioning the outboard motor in a selected motor-operating configuration.

6. The lift assembly of claim 5 wherein the outboard motor has a throttle arm and comprising a throttle extension provided on the throttle arm of the outboard motor for extending operation of the throttle arm of the outboard motor.

7. The lift assembly of claim 1 comprising at least one spring mechanism provided in said transom bracket, said spring mechanism engaging said motor mount bracket for counteracting the weight of the outboard motor as said upper links and said lower links pivot freely upwardly when the outboard motor strikes an underwater obstacle.

8. The lift assembly of claim 7 wherein said support mechanism comprises a control handle; a pawl pivotally provided on said control handle; a toothed bar carried by said transom bracket for releasable engagement with said pawl; a release device carried by said control handle and connected to said pawl for selectively causing engagement of said pawl and said toothed bar; and a link support apparatus pivotally connected to said control handle for engaging said lower links and selectively raising and lowering said lower links and the outboard motor responsive to manipulation of said release device and said control handle.

9. The lift assembly of claim 8 wherein said link support apparatus comprises a pair of lift bar links pivotally connected to said control handle; a lift bar pivotally connected to said lift bar links; and a lift sleeve carried by said lift bar for engaging and supporting said lower links and positioning the outboard motor in a selected motor-operating configuration.

10. The lift assembly of claim 9 wherein the outboard motor has a throttle arm and comprising a throttle extension provided on the throttle arm of the outboard motor for extending operation of the throttle arm of the outboard motor.

11. The lift assembly of claim 7 wherein said at least one spring mechanism comprises a pair of spring cables having one end thereof connected to said motor mount bracket and the opposite end of said spring cables extending to said motor mount bracket and a pair of springs having one end thereof connected to said transom bracket and the opposite end of said springs connected to said opposite end of said spring cables, respectively, for said counteracting the weight of the outboard motor as said upper links and said lower links pivot freely upwardly when the outboard motor strikes an underwater obstacle.

12. The lift assembly of claim 11 wherein said support mechanism comprises a control handle; a pawl pivotally provided on said control handle; a toothed bar carried by said transom bracket for releasable engagement with said pawl; a release device carried by said control handle and connected to said pawl for selectively causing engagement of said pawl and said toothed bar; and a link support apparatus pivotally connected to said control handle for engaging said lower links and selectively raising and lowering said lower links and the outboard motor responsive to manipulation of said release device and said control handle.

13. The lift assembly of claim 12 wherein said link support apparatus comprises a pair of lift bar links pivotally connected to said control handle; a lift bar pivotally connected to said lift bar links; and a lift sleeve carried by said lift bar for engaging and supporting said lower links and positioning the outboard motor in a selected motor-operating configuration.

14. The lift assembly of claim 1 wherein the outboard motor has a throttle arm and comprising a throttle extension provided on the throttle arm of the outboard motor for extending operation of the throttle arm of the outboard motor.

15. An outboard motor lift assembly for automatically raising and lowering an outboard motor from contact with underwater impediments, said motor lift assembly comprising: a transom bracket apparatus adapted to be secured to the transom of the boat; a motor mount bracket spaced-apart from said transom bracket apparatus for receiving an outboard motor; parallel sets of upper and lower links pivotally interconnecting said motor mount bracket and said transom bracket, wherein the motor mount bracket and the outboard motor may freely rise responsive to contact with the underwater impediment; and a handle apparatus movable within the boat and extending beneath said lower links for engaging said lower links and manually raising or lowering the outboard motor.

16. The lift assembly of claim 15 wherein the outboard motor has a throttle arm and comprising a throttle extension provided on the throttle arm of the outboard motor for extending operation of the throttle arm of the outboard motor.

17. The lift assembly of claim 15 wherein said handle apparatus comprises a control handle; a pawl pivotally provided on said control handle; a toothed bar carried by said transom bracket for releasable engagement with said pawl; a release device carried by said control handle and connected to said pawl for selectively causing engagement of said pawl and said toothed bar; and a link support apparatus pivotally connected to said control handle for engaging said lower links and selectively raising and lowering said lower links and the outboard motor responsive to manipulation of said release device and said control handle.

18. The lift assembly of claim 15 comprising at least one spring mechanism provided in said transom bracket, said spring mechanism engaging said motor mount bracket for counteracting the weight of the outboard motor as said upper links and said lower links pivot freely upwardly when the outboard motor strikes an underwater obstacle.

19. The lift assembly of claim 17 wherein said link support apparatus comprises a pair of lift bar links pivotally connected to said control handle; a lift bar pivotally connected to said lift bar links; and a lift sleeve carried by said lift bar for engaging and supporting said lower links and positioning the outboard motor in a selected motor-operating configuration and comprising a pair of spring cables having one end thereof connected to said motor mount bracket and the opposite end of said spring cables extending to said motor mount bracket and a pair of springs having one end thereof connected to said transom bracket and the opposite end of said springs connected to said opposite end of said spring cables, respectively, for said counteracting the weight of the outboard motor as said upper links and said lower links pivot freely upwardly when the outboard motor strikes an underwater obstacle.

20. An outboard motor lift assembly for automatically raising and lowering an outboard motor from contact with underwater impediments, said motor lift assembly comprising: a transom bracket assembly adapted to be secured to the transom of the boat; a motor mount bracket assembly spaced-apart from said transom bracket assembly for receiving an outboard motor; parallel sets of upper and lower links pivotally interconnecting said motor mount bracket assembly and said transom bracket assembly for pivotal movement of said motor mount bracket assembly and the outboard motor with respect to said transom bracket assembly; a handle apparatus movable within the boat; and a support element carried by said handle apparatus, said support element extending beneath said lower links for engaging and supporting said lower links and the outboard motor at a selected height, wherein said motor mount bracket assembly and the outboard motor may freely rise from said support element responsive to contact of the motor with the underwater impediments and said motor mount bracket assembly and the outboard motor may freely return to resting of said lower links on said support element after the motor has passed over the underwater impediments.
